(19) United States
(12) Patent Application Publication
(10) Pub. No.: US 2013/0232020 A1
(43) Pub. Date: Sep. 5, 2013

(54) METHOD FOR PREVENTING ILLEGAL RELOCATION AND COMMUNICATION RETRANSMISSION AND DEVICE THEREOF

(71) Applicant: Xianghong Liu, Shenzhen (CN)

(72) Inventor: Xianghong Liu, Shenzhen (CN)

(73) Assignee: SHENZHEN XINGUODU TECHNOLOGY CO., LTD., Shenzhen, Guangdong (CN)

(21) Appl. No.: 13/883,577

(22) PCT Filed: Aug. 31, 2012
(86) PCT No.: PCT/CN2012/080879

§ 371 Date: May 6, 2013

(30) Foreign Application Priority Data
Oct. 28, 2011 (CN) 201110333396.8

(51) Int. Cl. G06Q 20/20

(52) U.S. Cl. CPC G06Q 20/206
USPC 705/18

(57) ABSTRACT

A method for preventing illegal relocation and communication retransmission includes a fixed terminal arranged in an electronic equipment service area and a movable terminal arranged in the electronic equipment. The movable terminal accesses to and is registered with the fixed terminal to be bound with the same, in-place confirming communication is carried out between the movable and fixed terminals regularly or irregularly, the fixed terminal judges whether the movable terminal is located in a limited service area according to the communication transmission time, the movable terminal is not located in the limited service area and stops working and/or sends an alarm if the difference between the communication transmission time and the preset time value is larger than the set range and contrarily works normally. The defect that service areas of terminals of the electronic equipment cannot be limited in the prior art is effectively overcome by the present invention.

### FIELD OF THE INVENTION

The present invention relates to financial communication technology, and more particularly to a method for preventing illegal relocation and communication retransmission and a device thereof, so as to limit the service spaces of electronic equipments such as POS machines.

### BACKGROUND OF THE INVENTION

With the promotion and application of information technology, in our life and work, more and more electronic ways for currency settlement have been adopted. The electronic currency settlement way not only has advantages of convenience and speed, but also can reduce the cash pressure of the central bank. At present, the electronic settlement way has been applied to the settlement of various industries such as shopping in the department store and high-end consumption in exclusive shop, also applied to some entertainment venues such as karaoke parlors, bars, theatres and so on, and further applied to some special industries, such as gas stations, stops, toll stations, parks and so on. Because the electronic currency settlement is on the base of the electronic currency medium of bank such as debit cards, credit cards and so on, thus the POS machines and various new type portable electronic equipments with checkout function are needed. At present, the financial institutions such as UnionPay charge different service fees for the use of the electronic equipment such as POS machine in different industries, because of different industries having different profit rates produced in the consumption process, the industries with low profit rate such as department stores will be charged lower proportion for service fees, while some industries such as bars, karaoke parlors, restaurants and so on will be charged more serve fees. Thus, not a few users of the electronic equipments such as POS machines adopt a settlement terminal provided for the department stores and move it to other places such as bars, disco and so on for settlement, thereby achieving the purpose of paying fewer commission charges. However, the POS type electronic equipments provided by various manufacturers for the financial institutions such as UnionPay can not limit their service spaces.

Thus, it is necessary to provide a method for preventing illegal relocation and communication retransmission and a device thereof so as to prevent an electronic equipment, such as a POS machine and so on, from being moved and used illegally, thereby solving above defects.

### SUMMARY OF THE INVENTION

One object of the present invention is to provide a method for preventing illegal relocation and communication retransmission to overcome the disadvantages of the prior art.

Another object of the present invention is to provide a device for preventing illegal relocation and communication retransmission to overcome the disadvantages of the prior art.

To achieve above objects, the method for preventing illegal relocation and communication retransmission includes a fixed terminal arranged in an electronic equipment service area and a movable terminal arranged in the electronic equipment; the movable terminal accesses to and is registered with the fixed terminal to be bound with the fixed terminal; in-place confirming communication is carried out between the movable terminal and the fixed terminal regularly or irregularly; and the fixed terminal judges whether the movable terminal is located in a limited service area according to the communication transmission time during the in-place confirming communication with the movable terminal, the movable terminal is not located in the limited service area and stops working and/or sends an alarm if the difference between the communication transmission time and a preset time is larger than a setting range, and contrarily works normally.

In a preferred embodiment of the present invention, an initiating terminal of the in-place confirming communication is the movable terminal or the fixed terminal; the initiating terminal has a timer arranged therein to send an in-place confirming request periodically or at every time before starting up; the initiating terminal also has a clock arranged therein to record the communication transmission time of the in-place confirming communication; the communication transmission time can be determined by subtracting a constant confirmation processing time of a receiving terminal from a time difference of the procedure from the initiating terminal sending the in-place confirming request to receiving corresponding in-place response information; the constant confirmation processing time is larger than the maximum of the normal confirmation processing time of the receiving terminal; and after receiving the in-place confirming request, the receiving terminal starts an in-place confirming process and simultaneously starts to time until the time accumulated to the constant confirmation processing time and then makes an in-place confirming response.

Preferably, the communication between the fixed terminal and the movable terminal is built by a point-to-point direct physical connection way or wireless communication way, and the physical links of each communication are totally the same; the point-to-point direct physical connection way includes RS232 serial port line, RS485 serial port line, twisted pair of Ethernet or telephone line for dialing; and the wireless communication way includes 2.4 G wireless transmission, infrared transmission, Bluetooth transmission or near-field wireless data transmission.

Preferably, an encrypting communication way is adopted when carrying out the access and register and the in-place confirming communication between the fixed terminal and the movable terminal.

To achieve above objects, the device for preventing illegal relocation and communication retransmission provided by the present invention includes a fixed terminal with an anti-removing mechanism and arranged in an electronic equipment service area and a movable terminal arranged in the electronic equipment; fixed terminal includes a signal sending module, a signal receiving module, a comparator, a clock and a microcontroller therein; under the control of the microcontroller, the signal sending module sends a detection signal to the movable terminal of the electronic equipment; after receiving the detection signal, the movable terminal starts an in-place confirming process and simultaneously starts to time until the time accumulated to a preset constant confirmation processing time and then makes an in-place confirming response; the signal receiving module receives a response feedback signal from the movable terminal; the clock records the response time of the procedure from the signal sending module sending the detection signal to the signal receiving module receiving the feedback signal; the comparator compares the time difference, which is determined by subtracting the constant confirmation processing time of the movable terminal from the response time, with a preset time; the electronic equipment with the movable terminal is illegally relocated or subjected to communication retransmission if the difference between the time difference and the preset time is larger than a setting range and contrarily the movable terminal is in normal use.

Preferably, the anti-removing mechanism includes an acceleration transducer, which is arranged in the fixed terminal and will output a signal to the microcontroller of the fixed terminal so as to prohibit any communication between the fixed terminal and the movable terminal when the fixed terminal is removed.

Preferably, the anti-removing mechanism is a protective cover with a mechanical lock, and the protective cover further has a protective circuit which will output a signal to the microcontroller of the fixed terminal so as to prohibit any communication between the fixed terminal and the movable terminal when the protective cover is disassembled.

Preferably, the anti-removing mechanism is a GPS module, which is arranged in the fixed terminal and will output a signal to the microcontroller of the fixed terminal so as to prohibit any communication between the fixed terminal and the movable terminal when the fixed terminal is removed.

Preferably, the fixed terminal is arranged on the normal business communication channel of the electronic equipment and transparently transmits the normal business communication data of the electronic equipment without processing.

Preferably, the electronic equipment is a POS machine.

Compared with the prior art, the method for preventing illegal relocation and communication retransmission of the present invention utilizes the characteristic that the communication transmission time of two communication terminals is constant when their relative position is constant, thereby setting a movable terminal in the electronic equipment and simultaneously setting a fixed terminal in the service area of the electronic equipment, binding the movable terminal with the fixed terminal and then carrying out in-place confirming communication, and judging whether the electronic equipment is illegally relocated or subjected to communication retransmission according to the comparison between the communication transmission time of above communication process and the preset time. The present invention can effectively overcome the defect that the service area of the electronic equipment such as a POS machine can not be limited in the prior art, thereby bringing benefit to the stability of the consumer market and the development of the electronic currency trade.

The present invention will become more clear by means of the following description combining the accompanying drawings, which are used to illustrate embodiments of the present invention.

### BRIEF DESCRIPTION OF THE DRAWINGS

FIG. 1 is a block schematic diagram of a device for preventing illegal relocation and communication retransmission according to a specific embodiment of the present invention;

FIG. 2 is a flow schematic diagram of a method for preventing illegal relocation and communication retransmission according to a specific embodiment of the present invention;

FIG. 3 is a schematic diagram illustrating in-place confirming communication procedure according to a method for avoiding illegal relocation of the present invention.

### DESCRIPTION OF THE LABELS IN THE FIGURES

Electronic equipment 100; fixed terminal 200; signal sending module 210; signal receiving module 220; alarm module 230; comparator 240; clock 250, 320; microcontroller 260; timer 270; movable terminal 300; processor 310; communication module 330; anti-removing mechanism 400.

### DETAILED DESCRIPTION OF ILLUSTRATED EMBODIMENTS

The technical solutions of embodiments will be clear and completely described as follows by combining the figures of the embodiments of the present invention, and similar labels in the figures represent similar components. Obviously, the embodiments described as follows are merely parts of embodiments of the present invention, but not the all. Based on the embodiments of the present invention, other embodiments created by one of ordinary skill in the art without creative work, all belong to the scope of the present invention.

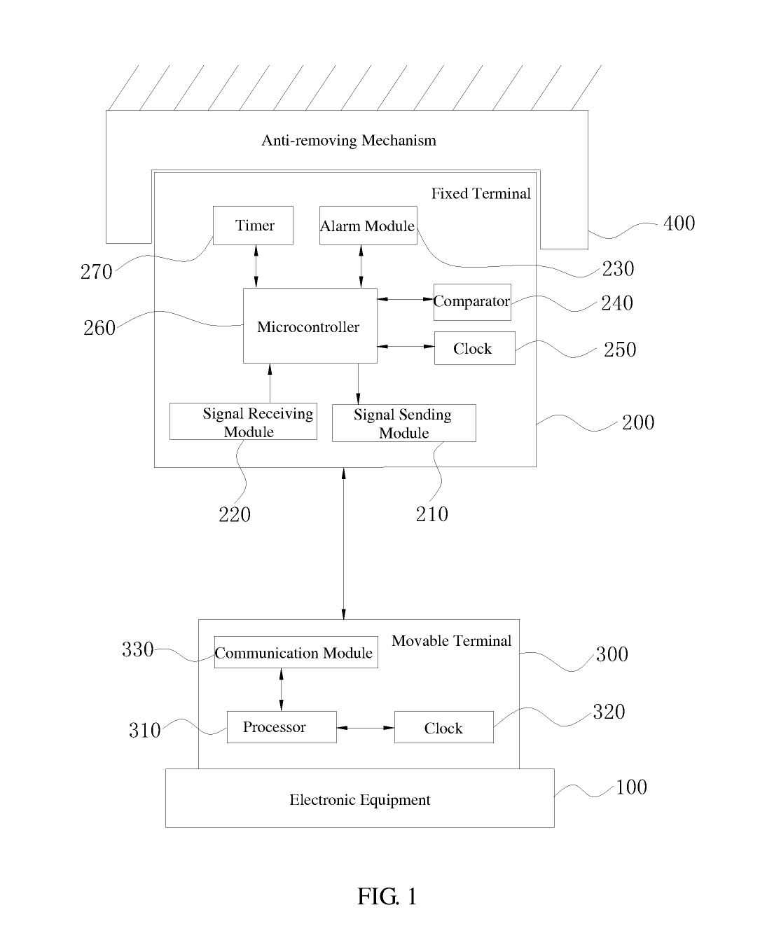

Firstly, please referring to FIG. 1, the device for preventing illegal relocation and communication retransmission provided by the present invention includes a fixed terminal 200 arranged in an electronic equipment service area 100 and a movable terminal 300 arranged in the electronic equipment 100. The movable terminal 300 can access to the fixed terminal 200 and be registered with the fixed terminal 200 so as to be bound with the fixed terminal 200, and an in-place confirming communication is carried out between the movable terminal 300 and the fixed terminal 200 regularly or irregularly. Preferably, an encrypting communication way is adopted when carrying out the access and register and the in-place confirming communication between the fixed terminal 200 and the movable terminal 300. An initiating terminal of the in-place confirming communication can be the movable terminal 300 or the fixed terminal 200, and this embodiment chooses the fixed terminal 200 as an initiating terminal of the in-place confirming communication and the movable terminal 300 accordingly as a receiving terminal to illustrate.

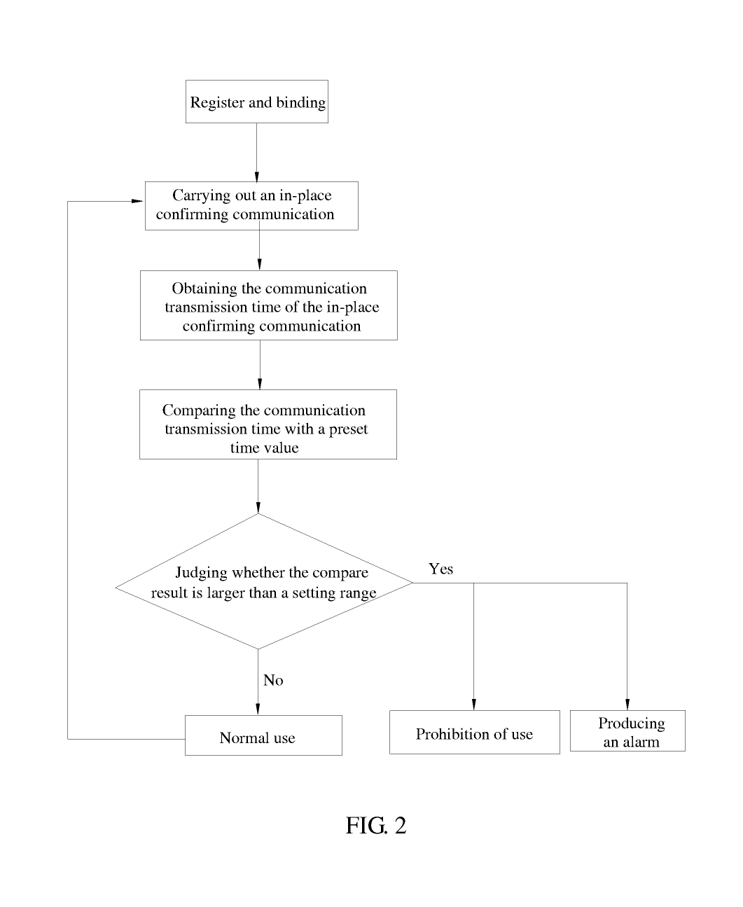

Referring to FIG. 1 again and combining FIG. 2, in this embodiment, the fixed terminal includes a signal sending module 210, a signal receiving module 220, an alarm module 230, a comparator 240, a clock 250 and a microcontroller 260, all of which are arranged therein; and the movable terminal 300 includes a processor 310, a clock 320 and a communication module 330, all of which are arranged in the movable terminal 300. Under the control of the microcontroller 260, the signal sending module 210 of the fixed terminal 200 sends a detection signal to the movable terminal 300 of the electronic equipment 100, and the signal receiving module 220 receives a response feedback signal from the movable terminal 300. The clock 250 of the fixed terminal 200 is used for recording the response time of the procedure from the signal sending module 210 sending the detection signal to the signal receiving module 220 receiving the feedback signal. The procedure from the fixed terminal 200 sending a detection signal to receiving a response feedback signal is in-place confirming communication, wherein, the detection signal sent by the fixed terminal 200 is an in-place confirming request which can be sent at every time before starting up and/or be sent periodically via a timer 270 arranged in the fixed terminal 200 (the initiating terminal), while the response feedback signal received by the fixed terminal 200 is the in-place response information returned from the movable terminal 300. The actual communication transmission time of above-mentioned in-place communication process can be determined by subtracting the time used for carrying out confirmation processing by the movable terminal 300 from above-mentioned response time. After the movable terminal 300 receiving the in-place confirming request, its processor 310 begins to carry out the in-place communication processing and simultaneously its clock 320 starts to time, when the time is accumulated to a preset constant confirmation processing time (this constant confirmation processing time should be larger than the maximum value of the normal confirmation processing time of the movable terminal 300 so as to ensure that the movable terminal 300 can finish the in-place confirming processing within that time), it makes an in-place confirming response. The comparator 240 is used for comparing the communication transmission time of the above-mentioned in-place confirming communication with a preset time (the maximal communication transmission time needed when the movable terminal 300 makes a communication with the fixed terminal 200 within the legal communication ranges), if the difference between the time difference and the preset time is larger than a setting range, it means that the communication transmission distance between the fixed terminal 200 and the movable terminal 300 has been increased (the electronic equipment has been moved and used illegally), or the communication information therebetween has been retransmitted by a transfer station thereby increasing its communication transmission time, under such a situation, it can be judged that the electronic equipment 100 with the movable terminal 300 has been moved and used illegally or subjected to communication retransmission, thus, the use of the movable terminal 300 will be prohibited and simultaneously the alarm module 230 arranged in the fixed terminal 200 will be activated to produce an alarm, if above-mentioned situation has not happened, the movable terminal 300 will be in normal use.

Preferably, in this embodiment, the fixed terminal 200 has an anti-removing mechanism 400 which includes an acceleration transducer arranged in the terminal 200. The acceleration transducer will output a signal to the microcontroller 260 of the fixed terminal 200 so as to prohibit any communication between the fixed terminal 200 and the movable terminal 300 when the fixed terminal 200 is removed. In another preferable embodiment, the anti-removing mechanism 400 can be a protective cover with a mechanical lock. The protective cover further has a protective circuit which will output a signal to the microcontroller 260 of the fixed terminal 200 so as to prohibit any communication between the fixed terminal 200 and the movable terminal 300 when the protective cover is disassembled. Additionally, the anti-removing mechanism 400 also can be a GPS module arranged in the fixed terminal 200. The GPS module will output a signal to the microcontroller 260 of the fixed terminal 200 so as to prohibit any communication between the fixed terminal 200 and the movable terminal 300 when the fixed terminal 200 is removed. Above-mentioned various anti-removing mechanisms 400 are provided for ensuring that the position of the fixed terminal 200 will not be changed, thereby determining the rang of the service space of the movable terminal 300 of the electronic equipment 100 so as to further avoid a situation of producing illegal relocation.

Preferably, the communication between the fixed terminal 200 and the movable terminal 300 is built by a point-to-point direct physical connection way, the physical links of each communication are totally the same; the point-to-point direct physical connection way includes RS232 serial port line, RS485 serial port line, twisted pair of Ethernet or telephone line for dialing. Additionally, the communication between the fixed terminal 200 and the movable terminal 300 also can be built by wireless communication way, the wireless communication way includes 2.4 G wireless transmission, infrared transmission, Bluetooth transmission or near-field wireless data transmission. Preferably, the fixed terminal 200 is arranged on the normal business communication channel of the electronic equipment 100 and transparently transmits the normal business communication data of the electronic equipment 100 without processing.

Referring to FIG. 2, the method for preventing illegal relocation and communication retransmission of the present invention will be described as follows: when the movable terminal 300 is used for the first time, firstly, the movable terminal 300 needs to access to and be registered with the fixed terminal 200 so as to be bound with the fixed terminal 200; next, the movable terminal 300 makes in-place confirming communication with the fixed terminal 200 regularly or irregularly, in this procedure, the fixed terminal 200 sends an in-place confirming request to the movable terminal 300, the movable terminal 300 makes an in-place confirming processing after receiving the request and makes an in-place response when the preset constant confirmation processing time is up; the fixed terminal 200 judges whether the movable terminal 300 is still in the limited service area according to the communication transmission time of the in-place confirming communication, if the difference between the communication transmission time and the preset time is larger than the setting range, judging that the movable terminal 300 is not in the limited service area, the movable terminal 300 will stop working and/or produce an alarm, and contrarily the movable terminal 300 still works normally.

The working principle of the present invention will be illustrated as follows by taking a specific in-place confirming communication process for example.

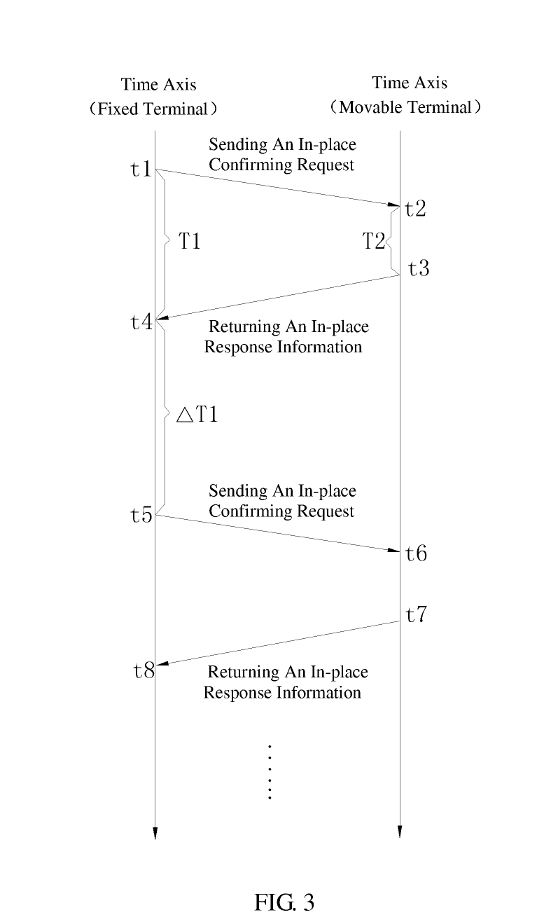

Referring to FIG. 3 and combining FIG. 1 and FIG. 2, in FIG. 3, the time showed by the time axis of left side where the fixed terminal 200 is located and the time showed by the time axis of right side where the movable terminal 300 is located are synchronous. The labels t1, t2, t3 and t4 showed in the time axis represent the moments of various actions produced by the fixed terminal 200 or the movable terminal 300. A single communication process for in-place confirming begins from the moment t1 and ends at the moment t4, and begins next in-place confirming communication process (from t5 to t8) after delaying for ΔT1 (this delay time can be set and achieved by the timer 270). Specifically, each in-place confirming communication process will be described as follows: the fixed terminal 200 sending in-place confirming communication request to the movable terminal 300 at the moment t1, the movable terminal 300 receiving this request at the moment t2 and then starting an in-place confirming process and simultaneously starting to time, when the time is accumulated to the moment t3, making an in-place confirming response and sending an in-place response information to the fixed terminal 200, via communication transmission, the fixed terminal 200 receiving this in-place response information at the moment t4, so the time difference between the moments t1 and t4 is the response time T1 of the in-place confirming process, and the time difference between the moments t2 and t3 is the constant confirmation processing time T2 of the movable terminal 300, which is predefined. The confirmation processing time needs to meet the need of being larger than the normal confirmation processing time so as to ensure that the movable terminal 300 can finish corresponding in-place confirming processing before the moment t3. In view of above analysis, it can be determined that the actual communication transmission time of the in-place confirming communication process is T=T1-T2, and because of T1=t4-t1 and T2=t3-t2, it also can be obtained that T=(t4-t3)+(t2-t1). Suppose that the preset time is T0 (the maximum value of the communication transmission time needed in the in-place confirming communication between the movable terminal and the fixed terminal), in general, it can be judged that the movable terminal 300 is not in the limited service area when the actual communication transmission time T is larger than the preset time T0, but according to the practical situation, it needs to relax this condition of judgment to allow the existence of errors, thus, above condition of judgment is set to whether the difference between the communication transmission time T and the preset time T0 is larger than the setting rang which can be set in accordance with specific conditions.

As described above, the method for preventing illegal relocation and communication retransmission of the present invention utilizes the characteristic that the communication transmission time of two communication terminals is constant when their relative position is constant, thereby setting a movable terminal 300 in the electronic equipment 100 and simultaneously setting a fixed terminal 200 in the service area of the electronic equipment 100, binding the movable terminal 300 with the fixed terminal 200 and then carrying out in-place confirming communication, and judging whether the electronic equipment 100 has been illegally relocated or subjected to communication retransmission according to the comparison between the communication transmission time of above communication process and the preset time. The present invention can effectively overcome the defect that the service area of the electronic equipment 100 such as a POS machine can not be limited in the prior art, thereby bringing benefit to the stability of the consumer market and the development of the electronic currency trade.

In the above-mentioned embodiments of the present invention, the electronic equipment 100 is a POS machine, however, it should be understood that the electronic equipment 100 is not limited to be a POS machine, other electronic equipments, which need to limit their service space, all can use the device and method provided by the present invention to achieve the limitation of service space.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A method for preventing illegal relocation and communication retransmission, comprising a fixed terminal arranged in an electronic equipment service area and a movable terminal arranged in the electronic equipment, wherein the movable terminal accesses to and is registered with the fixed terminal to be bound with the fixed terminal; in-place confirming communication is carried out between the movable terminal and the fixed terminal regularly or irregularly; and
the fixed terminal judges whether the movable terminal is located in a limited service area according to the communication transmission time during the in-place confirming communication with the movable terminal, the movable terminal is not located in the limited service area and stops working and/or sends an alarm if the difference between the communication transmission time and a preset time is larger than a setting range, and contrarily works normally.

2. The method for preventing illegal relocation and communication retransmission according to claim 1, wherein an initiating terminal of the in-place confirming communication is the movable terminal or the fixed terminal; the initiating terminal has a timer arranged therein to send an in-place confirming request periodically or at every time before starting up; the initiating terminal also has a clock arranged therein to record the communication transmission time of the in-place confirming communication; the communication transmission time can be determined by subtracting a constant confirmation processing time of a receiving terminal from a time difference of the procedure from the initiating terminal sending the in-place confirming request to receiving corresponding in-place response information; the constant confirmation processing time is larger than the maximum of the normal confirmation processing time of the receiving terminal; and after receiving the in-place confirming request, the receiving terminal starts an in-place confirming process and simultaneously starts to time until the time accumulated to the constant confirmation processing time and then makes an in-place confirming response.

3. The method for preventing illegal relocation and communication retransmission according to claim 1, wherein the communication between the fixed terminal and the movable terminal is built by a point-to-point direct physical connection way or wireless communication way, and the physical links of each communication are totally the same; the point-to-point direct physical connection way comprises RS232 serial port line, RS485 serial port line, twisted pair of Ethernet or telephone line for dialing; and the wireless communication way comprises 2.4 G wireless transmission, infrared transmission, Bluetooth transmission or near-field wireless data transmission.

4. The method for preventing illegal relocation and communication retransmission according to claim 1, wherein an encrypting communication way is adopted when carrying out the access and register and the in-place confirming communication between the fixed terminal and the movable terminal.

5. The device for preventing illegal relocation and communication retransmission, comprising a fixed terminal with an anti-removing mechanism and arranged in an electronic equipment service area and a movable terminal arranged in the electronic equipment, wherein fixed terminal comprises a signal sending module, a signal receiving module, a comparator, a clock and a microcontroller therein; under the control of the microcontroller, the signal sending module sends a detection signal to the movable terminal of the electronic equipment; after receiving the detection signal, the movable terminal starts an in-place confirming process and simultaneously starts to time until the time accumulated to a preset constant confirmation processing time and then makes an in-place confirming response; the signal receiving module receives a response feedback signal from the movable terminal; the clock records the response time of the procedure from the signal sending module sending the detection signal to the signal receiving module receiving the feedback signal; the comparator compares the time difference, which is determined by subtracting the constant confirmation processing time of the movable terminal from the response time, with a preset time; the electronic equipment with the movable terminal is illegally relocated or subjected to communication retransmission if the difference between the time difference and the preset time is larger than a setting range and contrarily the movable terminal is in normal use.

6. The device for preventing illegal relocation and communication retransmission according to claim 5, wherein the anti-removing mechanism comprises an acceleration transducer, which is arranged in the fixed terminal and will output a signal to the microcontroller of the fixed terminal so as to prohibit any communication between the fixed terminal and the movable terminal when the fixed terminal is removed.

7. The device for preventing illegal relocation and communication retransmission according to claim 5, wherein the anti-removing mechanism is a protective cover with a mechanical lock, and the protective cover further has a protective circuit which will output a signal to the microcontroller of the fixed terminal so as to prohibit any communication between the fixed terminal and the movable terminal when the protective cover is disassembled.

8. The device for preventing illegal relocation and communication retransmission according to claim 5, wherein the anti-removing mechanism is a GPS module, which is arranged in the fixed terminal and will output a signal to the microcontroller of the fixed terminal so as to prohibit any communication between the fixed terminal and the movable terminal when the fixed terminal is removed.

9. The device for preventing illegal relocation and communication retransmission according to claim 5, wherein the fixed terminal is arranged on the normal business communication channel of the electronic equipment and transparently transmits the normal business communication data of the electronic equipment without processing.

10. The device for preventing illegal relocation and communication retransmission according to claim 5, wherein the electronic equipment is a POS machine.
